(19) United States
(12) Patent Application Publication
(10) Pub. No.: US 2021/0114844 A1
(43) Pub. Date: Apr. 22, 2021

(54) Lifting Eye

(71) Applicant: J. D. Theile GmbH & Co. KG, Schwerte (DE)

(72) Inventors: Martin Foitzik, Schwerte (DE); Ivan Kresic, Schwerte (DE); Tim Murach, Schwerte (DE)

(21) Appl. No.: 17/069,580

(22) Filed: Oct. 13, 2020

(30) Foreign Application Priority Data
Oct. 21, 2019 (DE) 20 2019 105 837.4

(51) Int. Cl. B66C 1/66

(52) U.S. Cl. CPC B66C 1/66

(57) ABSTRACT

A lifting eye having a lower part, for connecting the lifting eye to an object to be handled or fastened, and a swivel eye. The lower part has a swivel part which can be rotated relative to the lower part. The swivel eye is pivotably mounted relative to the swivel part. The swivel eye has a bearing pin connected to each leg of the swivel eye. Each bearing pin engages in a bearing recess of the swivel part. The pivot axis of the swivel eye relative to the swivel part, which axis is defined by the bearing pins and their engagement in the bearing recesses of the swivel part, intersects the central longitudinal plane of the swivel eye.

### RELATED APPLICATION

This application claims priority to German application number DE 20 2019 105 837.4 filed Oct. 21, 2019, which is incorporated by reference herein for all purposes.

### BACKGROUND

The present disclosure relates to a lifting eye with a lower part having means for connecting the lifting eye to an object to be handled or fastened, and having a swivel part that can be rotated with respect to the lower part, a swivel eye or ring with a bearing pin connected to each leg engaging in a bearing recess of the swivel part and pivotably mounted with respect to the swivel part.

Such lifting eyes are used for lifting as well as for fastening objects. For this purpose, the lifting eyes are connected to the object to be lifted. A connection screw is typically used for the connection, which screw is passed through the lower part of the lifting eye. If a lifting eye is to be permanently connected to an object, the lower part can also be integrally joined to the object, typically by welding. For lifting or also for tying down an object, typically several lifting eyes are used for mounting a respective lifting gear. The lifting eye can be pivoted relative to the lower part such that, when lifting gear is mounted therein, the lifting eye can align with the tensile direction acting thereon, and the lifting eye can be rotated about the longitudinal axis of the lifting eye such that its apex can align with the direction of the tensile force applied. Therefore, such lifting eyes are also referred to as swivel rings. The same properties of a lifting eye are also desired when used for tying down an object.

Bearing pins are molded onto each of the legs of the lifting eye for making it pivotable relative to the lower part. These pins each engage in a corresponding bearing recess in the swivel part. Only such an articulated connection of the swivel ring relative to the lower part with its swivel part and the rotatable design of the swivel part with respect to the fixed components of the lower part allow an alignment of the swivel ring in the direction of the tensile force applied, at a small distance from the surface of the object to be handled or tied down. The goal is to keep a cantilever moment acting via the lifting eye as low as possible.

Such lifting eyes are for example known from DE 20 2005 011 967 U1, DE 10 2015 223 161 A1, or US 2004/0032134 A1.

With such a lifting eye, however, situations can arise in which the desired alignment of the swivel ring with its apex pointing in the direction of the transverse tensile force applied does not occur by itself. Admittedly, such conditions are rare. However, these can occur, which is particularly unfavorable in situations in which the alignment of the swivel ring cannot be manually influenced such that it aligns itself in the direction of the tensile force applied. Such a situation can arise, for example, when objects to be handled are lifted jointly with several cranes or are transferred from one crane to another. Such a forced position, i.e., a position of the swivel eye relative to the lower part, which does not automatically align with its apex in the direction of the tensile force applied, exists when the tensile force applied is aligned with the pivot axis of the swivel eye relative to the swivel part. While it can be expected that even when handling an object with several cranes, as described above, the swivel eye will align itself in the desired direction again in the course of further handling. But this happens all of a sudden, whereby the effective pulling length of the lifting device connected thereto is suddenly extended by the length of the swivel eye. This is undesirable, especially in the case of larger, difficult to handle and heavy objects, especially if they have to be installed with precise positioning, such as components of a wind turbine. Such a sudden drop, even if only over a few centimeters or tens of centimeters, resulting from the release from a forced position, represents not only a risk of damage to the component to be handled and possibly to be assembled, but also a danger to the fitters who are directly next to the object to be handled.

The foregoing examples of the related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools and methods which are meant to be illustrative, not limiting in scope. In various embodiments, one or more problems have been reduced or eliminated, while other embodiments are directed to other improvements.

Proceeding from this background, an aspect of the present disclosure is therefore to further develop a lifting eye of the type mentioned at the beginning such that it is not brought into a forced position like in the prior art, even if a tensile force applied is aligned with the pivot axis of the swivel eye relative to the swivel part, but that it smoothly aligns the swivel eye in the direction of the tensile force applied.

This is achieved by a generic lifting eye of the type mentioned at the outset, wherein the pivot axis of the swivel eye defined by the bearing pins and their engagement in the bearing recesses of the swivel part intersects the central longitudinal plane of the swivel eye relative to the swivel part, which plane extends in the plane of the swivel eye.

A special feature of this lifting eye is that the pivot axis of the swivel eye intersects the central longitudinal plane running in the plane of the swivel eye relative to the swivel part. This is achieved by a special arrangement of the bearing pins and, accordingly, of the bearing recesses in order to engage them in the bearing recesses of the swivel part, by which interaction the pivot axis is defined. If there is a transverse force on the swivel eye erected opposite the lower part, which is aligned with the pivot axis of the swivel eye relative to the swivel part, this does not result in a forced position, since when such a tensile force is applied it actually acts at an angle to the swivel eye plane. This force, which is applied at an angle with respect to the central longitudinal plane, induces a torque and thus leads to a rotary movement of the swivel eye relative to the lower part. If the swivel eye is rotated by a few angular degrees with respect to the fixed lower part, the force applied is no longer in alignment with the pivot axis, such that the swivel eye is then pivoted with respect to the swivel part and can align its apex with the direction of the tensile force applied. If another tensile force is applied to the upright swivel eye and a transverse force acts on the swivel eye in the plane of the central longitudinal plane, this also does not represent a forced position from which the swivel eye cannot free itself automatically. Due to the pivot axis intersecting the central longitudinal plane, a tilting moment is introduced in the event of such a load on the lifting eye, due to which load the swivel eye is pivoted from its upright position in the direction of the tensile force applied and then aligns its apex with the direction of the tensile force applied, which is accompanied by a rotary movement of the swivel eye and the swivel part relative to the fixed parts of the lower part. For this reason, no forced position as described for lifting eyes of the prior art will occur with this lifting eye. The described design of the lifting eye ensures that the swivel eye is aligned with the lower part, regardless of the transverse direction from which a tensile force acts on the swivel eye, with its apex in the direction of the applied tensile force.

According to one embodiment, the legs are angled in opposite directions with respect to the central longitudinal plane of the swivel eye. In principle, such a measure alone is sufficient to achieve the effect described above. The bearing recesses of the swivel part are dimensioned accordingly.

In a further development of such a lifting eye, the longitudinal axes of the bearing pins connected, typically molded, to the legs are oriented in the direction of the axis of rotation of the swivel part relative to the lower part, preferably to the extent that the longitudinal axes of the bearing pins are aligned with one another and an imaginary straight line connecting the longitudinal axes of the bearing pins intersects the axis of rotation of the swivel part with respect to the lower part or passes it at a small distance only.

According to one embodiment, the swivel eye of such a lifting eye is produced in a forging process. For this purpose, it is advisable to design the cross-sectional geometry of the bearing pins of the eye part to be oval, which simplifies the tool geometry and the desired easy release from the mold. However, the cross-sectional geometry of the bearing pins can also be designed differently, for example round or with a different cross-sectional geometry with rounded edges. In such a configuration, the long axis of the cross-sectional geometry extends perpendicular to the longitudinal extension of the swivel eye. The short axis is eccentrically offset with respect to the extension of the long axis, namely offset in the angular direction of the leg from the center.

If the swivel eye is designed as a forged part, it can easily have further elements, such as, for example, an eye web connecting the legs at a small distance from the end of the lower part on the swivel eye side. Such an eye web stiffens the swivel eye and ensures permanent engagement of the bearing pins molded to the ends of the legs in the complementary bearing recesses of the swivel part.

The angle at which the pivot axis of the swivel eye intersects the central longitudinal plane of the swivel eye relative to the lower part should be at least 10°. A design of such a lifting eye with a smaller angle between the pivot axis of the swivel eye relative to the lower part and the central longitudinal plane is possible in principle. However, against the background of existing static friction between the mutually movable elements, the acting tensile forces have a better desired effect if this angle is at least 10°. It also makes little sense to choose this angle to be excessively large, since then, in one embodiment of the lifting eye in which the legs are angled in opposite directions relative to the central longitudinal plane, the degree of angularity would be quite large, with the result that the legs molded to the bearing pins would have to be configured accordingly longer. This, however, is unfavorable for force transmission from the swivel eye to the lower part and vice versa. Currently preferred configurations have an angle between the pivot axis of the swivel eye relative to the lower part with the central longitudinal plane of the swivel eye of 12°-15°. The effect according to the present disclosure can also be achieved if the angle discussed above is less than 10°, but more reasonably it should be more than 4° to 5°.

In the case of the lifting eye described, the desired rotation of the swivel part relative to the other components of the lower part can be achieved in any desired manner. For example, rotation can be implemented via a slide bearing or via one or more ball or roller bearings.

In addition to aspects and embodiments described above, further aspects and embodiments will become apparent by reference to the appended drawings, wherein like reference numerals generally designate corresponding structures in the several views.

### BRIEF DESCRIPTION OF THE DRAWINGS

The present disclosure is described below using an example embodiment with reference to the attached figures, wherein:

FIG. 1 shows a perspective view of a lifting eye according to the present disclosure,

FIG. 2 shows a longitudinal sectional view through the lifting eye of FIG. 1,

FIG. 3 shows a side view of the swivel eye of the lifting eye of FIGS. 1 and 2,

FIG. 4 shows a sectional view of the lifting eye of FIG. 1, offset from the sectional view shown in FIG. 2,

FIG. 5 shows a horizontal sectional view through the lifting eye of FIG. 1 along the section line A-A of FIG. 2,

FIG. 6 shows the sectional view of the lifting eye of FIG. 5 with a tensile force acting on the swivel eye in alignment with its central longitudinal plane, and

FIG. 7 shows the sectional view of the lifting eye of FIG. 5 with a tensile force acting on the swivel eye in alignment with its pivot axis relative to the lower part.

Before explaining the depicted embodiments, it is to be understood that the invention is not limited in application to the details of the particular arrangements shown, since the invention is capable of other embodiments. The embodiments and figures disclosed herein are to be considered illustrative rather than limiting. Also, the terminology used herein is for the purposes of description and not limitation.

### DETAILED DESCRIPTION

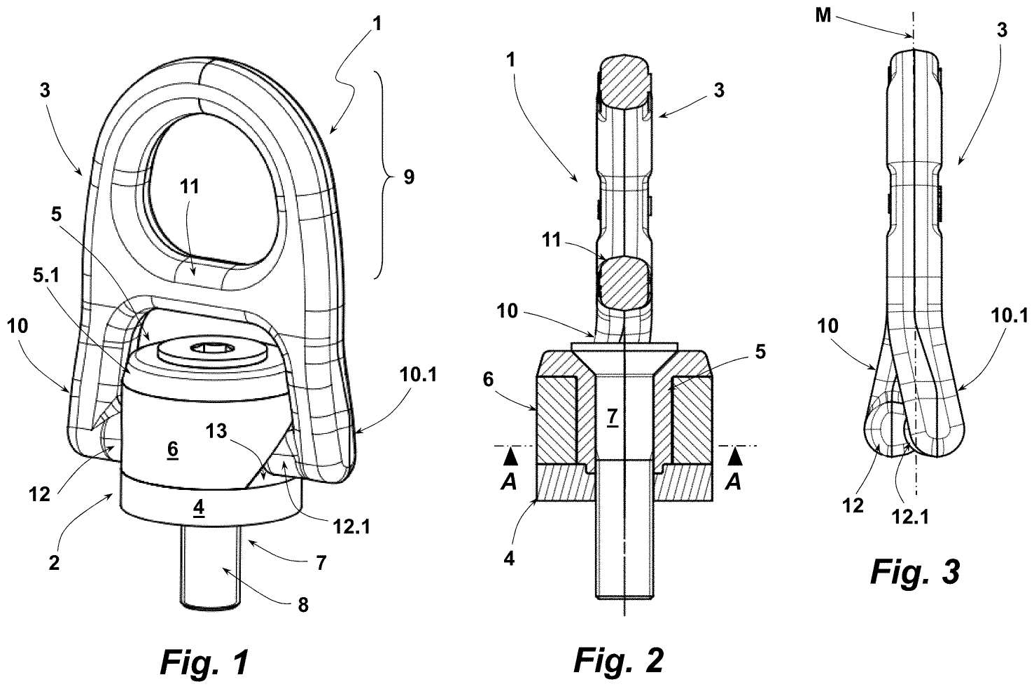

A lifting eye 1 comprises a lower part 2 and a swivel eye 3. The lower part 2 comprises a disc 4, a sleeve part 5, and a swivel part 6. The bottom side of the disc 4 rests against an object to be handled or tied down. Only the top flange end 5.1 of the sleeve part 5 protruding in the radial direction is visible in FIG. 1. The sleeve part 5 is connected to the disc 4 by a press fit (see FIG. 2). The swivel part 6 is an annular cylindrical component which can be rotated between the top side of the disc 2 and the bottom side of the flange end 5.1 of the sleeve part 5. A fastening screw 7, the shaft of which engages in the lower part 2, is used to connect the lifting eye 1 to an object to be handled or tied down. This screw 7 is also part of the lower part 2. The threaded section of the fastening screw 7 protruding from the lower part 2 is identified by reference numeral 8 in FIG. 1.

As can be seen from FIG. 2, the swivel part 6 is mounted relative to the sleeve part 5 and the disc 2 for rotation about the longitudinal axis of the sleeve part 5 in the manner of a slide bearing.

The swivel eye 3 of the embodiment shown has an upper stop section 9. In the embodiment shown, this section 9 is limited in the direction of the lower part of the lifting eye by an eye web 11 connecting the two legs 10, 10.1 of the swivel eye 3. The stop section 9 is used to insert a crane hook, a belt, or some other lifting or fastening means. The legs 10, 10.1 continue below the eye web 11. These each have a bearing pin 12, 12.1 on their inner, mutually facing sides. The protruding bearing pins 12, 12.1 molded onto the lower ends of the legs 10, 10.1 engage in the radial direction in the swivel part 6, which for this purpose has corresponding bearing recesses 13, 13.1 (see also FIG. 5).

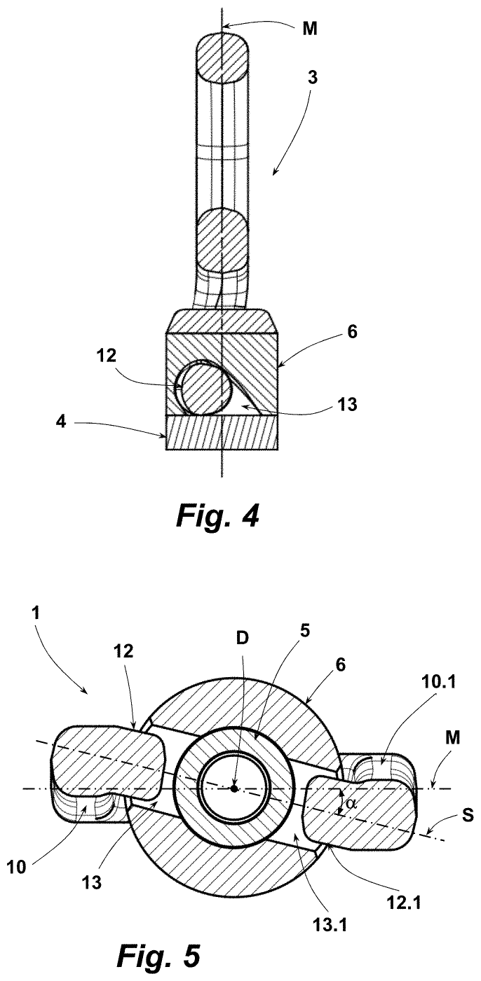

In the swivel eye 3 of the lifting eye 1, the lower sections of the legs 10, 10.1—the sections below the eye web 11—are angled in opposite directions relative to the central longitudinal plane M in the plane of the swivel eye 3, as can be seen from the perspective view of FIG. 1, but more clearly from the side view of the swivel eye 3 in FIG. 3 or from the sectional view in FIG. 4. The cross-sectional geometry of the bearing pins 12, 12.1 can be seen in FIG. 3 through the bearing pin 12. The cross-sectional geometry is oval-shaped, with the long axis running transversely to the central longitudinal plane M. The short axis is offset towards the outside in relation to the center of the cross-sectional area of the bearing pin 12 and thus in the disengagement direction of the leg end. Such a cross-sectional geometry is expedient if the swivel eye 3 is a forged part and has therefore been brought into its shape shown in FIG. 3 in a forging process.

FIG. 4 shows a sectional view corresponding to that of FIG. 2, but with the sectional plane not at the center of the swivel section of the eye, but offset towards the edge of the swivel part 6. This representation shows the bearing leg 12 and its engagement in the bearing recess 13 of the swivel part 6. The outline geometry of the bearing recess 13 can be seen from this illustration. The geometry of the bearing recess 13 is similar to the end section of an oblong hole formed inclined radially in the swivel part 6. The long axis of the bearing recess 13 is thus inclined with respect to the central longitudinal plane M. The reason for designing the bearing recess 13 in this shape is that the bearing pins 12, 12.1 are not only offset from one another due to the angled position of the legs 10, 10.1, but also shifted towards one another and thus towards the axis of rotation D of the swivel part 6 relative to the legs 10, 10.1. The respective design of the bearing pins 12, 12.1 can be seen in the sectional view in FIG. 5. The longitudinal axes of the bearing pins 12, 12.1 in this example embodiment are aligned with one another, the aligned long axes intersecting the axis of rotation D. This axis represents the pivot axis S of the swivel eye 3 relative to the swivel part 6.

The sectional view in FIG. 5 also shows how the legs 10, 10.1 are angled in opposite directions relative to the central longitudinal plane.

As shown in FIG. 5, the pivot axis S intersects the central longitudinal plane M. The angle of intersection a in the example embodiment shown is 12°.

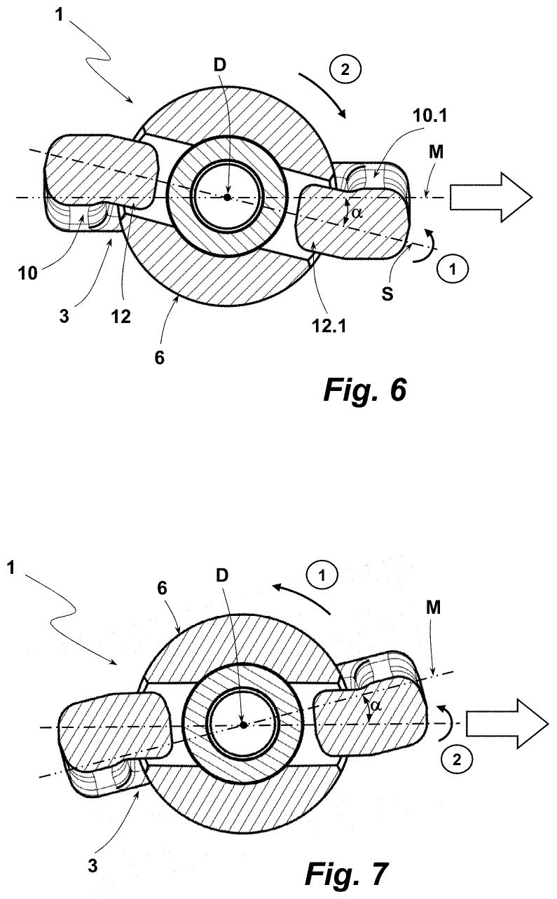

The design of the lifting eye 1 described above has the consequence that no forced position of the swivel eye 3 with respect to the lower part 2 can arise, so in every situation of force applied to an upright swivel eye 3 relative to the lower part 2, the eye will align in the direction of the tensile force applied. This applies, for example, to a position in which a tensile force acts in alignment with the central longitudinal plane M if the swivel eye 3 is upright relative to the lower part 2. This position of the swivel eye 3 with respect to the lower part 2 could result in a forced position with previously known lifting eyes. FIG. 6 shows the respective load on the lifting eye 1. The tensile force applied acts, as indicated by the block arrow, horizontally on the swivel eye 3 in alignment with the central longitudinal plane M. The applied force, shown schematically in FIG. 6, acts on the swivel eye 3 of the lifting eye 1 in alignment with the central longitudinal plane M, but at an angle to the pivot axis S relative to the lower part 2. As a result, the swivel eye 3 is initially pivoted about the pivot axis S by a certain amount and then aligns itself in the direction of the force applied by rotating about the axis of rotation D. These two steps are indicated in the figure. With such an application of force to the lifting eye 1, no forced position can occur.

FIG. 7 shows the lifting eye 1 with a tensile force applied in alignment with the pivot axis S. Since the tensile force is introduced at an angle to the central longitudinal plane M into the swivel eye 3, this induces a torque, such that after a rotation of the swivel part 3 about the axis of rotation D, the force is applied at an angle to the pivot axis S, and this in turn causes the swivel eye 3 to pivot relative to the swivel part 6, with the result that the swivel eye 3 in turn pivots and aligns in the direction of the tensile force applied. These two steps are also identified in this figure.

The above effects can also be achieved with a lifting eye not shown in the figures, in which the legs are shifted in directions facing away from each other with respect to the central longitudinal plane, but the bearing pins are not aligned, or approximately aligned, with their longitudinal axis. In such a configuration, too, the pivot axis intersects the central longitudinal plane. The introduction of force from the bearing pins into the bearing surface of the bearing recess is, however, improved in an embodiment in which the longitudinal axes of the bearing pins are shifted towards one another.

In the example embodiments described, the bearing pins of the legs engage in bearing recesses in the swivel part of the lower part. These bearing recesses can also be implemented by inserts inserted into the swivel part.

The invention has been described on the basis of example embodiments. Without deviating from the scope of the claims, a person skilled in the art will recognize numerous other options for implementing the invention, which options do not have to be mentioned herein. While a number of aspects and embodiments have been discussed herein, those skilled in the art will recognize numerous modifications, permutations, additions, combinations and sub-combinations therefor, without same needing to be specifically explained in the context of this disclosure. The appended claims should therefore be interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention claimed. Thus, it should be understood that although the present invention has been specifically disclosed by example embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure.

In general, the terms and phrases used herein have their art-recognized meaning, which can be found by reference to standard texts, references and contexts known to those skilled in the art. The above definitions are provided to clarify their specific use in the context of the invention.

### LIST OF REFERENCE NUMERALS

1 Lifting eye
2 Lower part
3 Swivel eye
4 Disc
5 Sleeve part
5.1 Flange end
6 Swivel part
7 Fastening screw
8 Threaded section
9 Stop section
10, 10.1 Leg
11 Eye web
12, 12.1 Bearing pin
13 Bearing recess
D Axis of rotation
M Central longitudinal plane
S Pivot axis

1. A lifting eye comprising:
a lower part for connecting the lifting eye to an object to be handled or fastened, the lower part having a swivel part which can be rotated relative to fixed parts of the lower part,
a swivel eye pivotably mounted relative to the swivel part, the swivel eye having two legs and a bearing pin connected to each leg, with each bearing pin engaging in a bearing recess of the swivel part,
wherein a pivot axis of the swivel eye relative to the swivel part, which is defined by the bearing pins and their engagement in the bearing recesses of the swivel part, intersects a central longitudinal plane of the swivel eye.

2. The lifting eye of claim 1, wherein the legs are angled in opposite directions relative to the central longitudinal plane of the swivel eye.

3. The lifting eye of claim 2, wherein longitudinal axes of the bearing pins molded onto the legs are oriented in the direction of an axis of rotation of the swivel part relative to the lower part.

4. The lifting eye of claim 3, wherein a straight line connecting the longitudinal axes of the bearing pins intersects the axis of rotation of the swivel part relative to the lower part or passes the axis of rotation at a distance.

5. The lifting eye of claim 4, wherein the bearing pins have an oval-shaped cross-sectional geometry with a long axis and a short axis, the long axis extends perpendicular to the longitudinal extension of the swivel eye, and the short axis is eccentrically offset in the angular direction of the respective leg onto which the bearing pin is molded.

6. The lifting eye of claim 3, wherein the bearing pins have an oval-shaped cross-sectional geometry with a long axis and a short axis, the long axis extends perpendicular to the longitudinal extension of the swivel eye, and the short axis is eccentrically offset in the angular direction of the respective leg onto which the bearing pin is molded.

7. The lifting eye of claim 2, wherein the bearing pins have an oval-shaped cross-sectional geometry with a long axis and a short axis, the long axis extends perpendicular to the longitudinal extension of the swivel eye, and the short axis is eccentrically offset in the angular direction of the respective leg onto which the bearing pin is molded.

8. The lifting eye of claim 7, wherein an angle of intersection enclosed by the pivot axis and the central longitudinal plane is at least 10°.

9. The lifting eye of claim 8, wherein the angle of intersection is 12°-15°.

10. The lifting eye of claim 2, wherein an angle of intersection enclosed by the pivot axis and the central longitudinal plane is at least 10°.

11. The lifting eye of claim 10, wherein the angle of intersection is 12°-15°.

12. The lifting eye of claim 1, wherein an angle of intersection enclosed by the pivot axis and the central longitudinal plane is at least 10°.

13. The lifting eye of claim 12, wherein the angle of intersection is 12°-15°.

14. The lifting eye of claim 1, wherein the swivel eye has an eye web connecting the two legs of the swivel eye.

15. The lifting eye of claim 1, wherein the swivel eye of the lifting eye is a forged part.

16. The lifting eye of claim 1, wherein the bearing recesses of the swivel part have a slot-like outline geometry, and a long axis of the slot-like outline geometry is inclined with respect to a vertical.

17. The lifting eye of claim 1, wherein the swivel part is rotatable relative to the fixed parts of the lower part via a slide bearing.
